(19) United States
(12) Patent Application Publication
(10) Pub. No.: US 2009/0282751 A1
(43) Pub. Date: Nov. 19, 2009

(54) SELF MEASURING VINYL SIDING

(75) Inventors: Christopher Adam Orfield, Meadowview, VA (US); Tony L. Orfield, Meadowview, VA (US)

Correspondence Address: SUGHRUE MION, PLLC, 2100 PENNSYLVANIA AVENUE, N.W., SUITE 800, WASHINGTON, DC, 20037, US

(73) Assignee: VISUAL MEASUREMENT TECHNOLOGY LLC, Meadowview, VA (US)

(21) Appl. No.: 12/121,352

(22) Filed: May 15, 2008

(51) Int. Cl. E04F 19/00; G06F 19/00; E04B 1/00; B26D 1/00; B29C 47/00

(52) U.S. Cl. 52/105; 52/519; 83/13; 264/238; 700/196

(57) ABSTRACT

An elongated piece of pre-finished vinyl siding adapted to be cut to a measured length at a worksite and to be affixed to a structure includes an upper portion that includes a nailing flange and a locking lip portion. Linear dimension markings non-repetitively and incrementally are provided exclusively on the upper portion, wherein the linear dimension markings increase sequentially from a first end edge to a second end edge of the vinyl siding along an entire length of the vinyl siding, thereby visually indicating where to cut the vinyl siding to obtain the measured length. The linear dimension markings are completely hidden from view when the vinyl siding is affixed adjacently with other vinyl siding pieces to the structure.

### BACKGROUND OF THE INVENTION

1. Field of the Invention

This invention provides a novel and unique measurement system for cutting vinyl siding and components thereof including corner post, J-channel, F-channel, fascia, undersill and the like, and a method for manufacturing such a measurement system.

2. Description of the Prior Art

Heretofore, cutting vinyl siding to size on the job has involved the time consuming steps of placing the piece of siding, which typically is 10 to 20 feet in length, on a table or other flat support, taking up a tape measure and hooking the end thereof to an end of the siding piece, extending the tape measure out along the siding piece without dislodging the hook end thereof from the siding piece, marking on the siding piece the desired cut point, removing the tape measure from the siding piece, retracting the tape measuring, replacing the tape measure at its storage place, placing the siding piece in a position on the support to be cut on the mark, and cutting the siding piece.

The time involved in carrying out these steps does not, at first glance, appear as a significant time expenditure; however, for example, for a typical days vinyl siding work on a large home, the cutter operator will use a tape measure hundreds of times and easily expend an hour or so each day in just measuring and marking.

### SUMMARY OF THE INVENTION

The present invention eliminates such wasteful time expenditure by providing an elongated piece of pre-finished vinyl siding with its own ruler (linear dimension) markings provided directly thereon, for example along one or more edges thereof such that the cutter operator need only to cut on the mark already on the siding piece as it is called out by the siding installer, e.g., “thirteen feet, one and one quarter inches”.

According to an aspect of the invention, an elongated piece of pre-finished vinyl siding adapted to be cut to a measured length at a worksite and to be affixed to a structure can be cut accurately without the need for a tape measure or the like.

More specifically, according to the present invention, an elongated piece of pre-finished vinyl siding adapted to be cut to a measured length at a worksite and to be affixed to a structure, includes an upper portion that includes a nailing flange and a locking lip portion, and linear dimension markings non-repetitively and incrementally provided exclusively on the upper portion. The linear dimension markings increase sequentially from a first end edge to a second end edge of the vinyl siding along an entire length of the vinyl siding, thereby visually indicating where to cut the vinyl siding to obtain the measured length. The linear dimension markings are completely hidden from view when the vinyl siding is affixed adjacently with other vinyl siding pieces to the structure.

According to yet another aspect of the invention, a group of elongated pre-finished vinyl siding panels is provided, each of which has an upper portion extending longitudinally along a length of the vinyl siding panel, a lower portion extending longitudinally along a length of the vinyl siding panel, and a first end edge and a second end edge. Each panel is provided with highly visible linear measure markings on the upper portion, whereby the vinyl siding panel can be cut by an installer to a desired length utilizing, for measuring, only the markings and without the need for any other measuring device, wherein the markings are non-repetitively, continuously increasing sequentially from zero at the first end edge to n at the second end edge, wherein n equals a total length of the vinyl siding panel. The upper portion includes a nailing flange and a locking lip portion of the vinyl siding panel, and wherein the vinyl siding panels are affixed in typical assembly manner to a building wherein an upper vinyl siding panel is adjacent to a lower vinyl siding panel of the same construction and the lower portion of the upper vinyl siding panel overlies the upper portion of the lower vinyl siding panel and obscures the markings on the upper portion of the lower vinyl siding panel so that the markings cannot be viewed after all the panels are installed to the building.

A method consistent with the present invention of cutting a piece of vinyl siding having pre-printed linear dimension markings thereon, wherein the markings are continuously and non-repetitively provided on a surface of the vinyl siding, increasing sequentially from a first end edge to a second end edge of the vinyl siding along an entire length of the vinyl siding, thereby visually indicating where to cut the vinyl siding, includes determining a desired length for the vinyl siding with reference to a structure to which the vinyl siding is to be affixed; viewing the pre-printed linear dimension markings on the vinyl siding to locate a corresponding one of the pre-printed linear dimension markings that equals the desired length, thereby determining a position on the vinyl siding to be cut without using an additional measurement tool; and cutting the vinyl siding at the corresponding linear dimension marking that equals the desired length.

A method consistent with the present invention for manufacturing a pre-finished vinyl siding panel with linear dimension markings includes extruding a vinyl siding panel from an extruder. Linear dimension markings are printed with a printer, along a longitudinal upper portion of the vinyl siding panel simultaneously with the extruding step, upon detection of a leading edge of the vinyl siding panel reaching the printer. Simultaneously with the continued process of the printing step, a distal end of the vinyl siding panel is cut upon detection that a predetermined length of the vinyl siding panel has been extruded from the extruder. After the cutting step, the printing step is continued without interruption until a distal end portion of the vinyl siding has been printed and the printing is then stopped. After the printing is stopped, a phasing process is conducted for analyzing and adjusting the static charge placed on ink drops of the printer.

### BRIEF DESCRIPTION OF THE DRAWINGS

The invention will be understood further from the drawings herein and description wherein structural portions are not drawn to scale and are enlarged for clarity, wherein:

FIG. 1 is a perspective view of a piece of a vinyl siding panel with the present linear measure markings in one inch increments (for purposes of clarity) provided along a portion of its longitudinal nailing flange;

FIG. 2 is an end view of the panel of FIG. 1 showing a portion of an upper overlapping panel which obscures the markings;

FIG. 3 is a view as in FIG. 1 showing an inset left edge and linear dimension numbering;

FIG. 4 shows portions of a building structure with vinyl siding (enlarged for clarity) affixed thereto in accordance with the present invention with portions of the siding broken away for clarity;

FIG. 5 illustrates the linear measurement markings in detail; and

FIG. 6 illustrates a flow chart indicating a method of manufacturing the vinyl siding.

### DETAILED DESCRIPTION OF THE PRESENT INVENTION

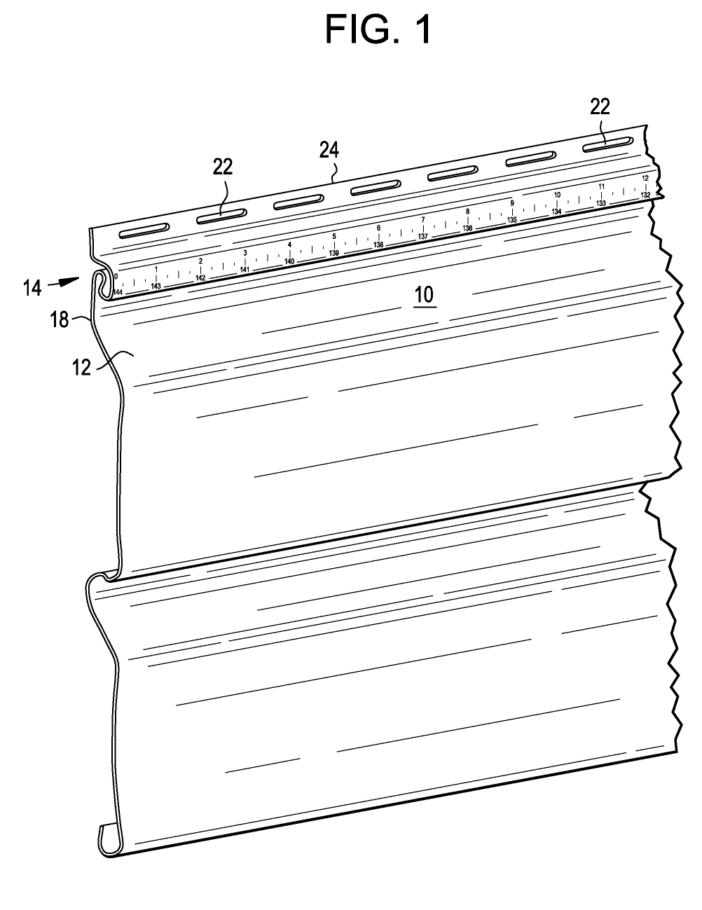

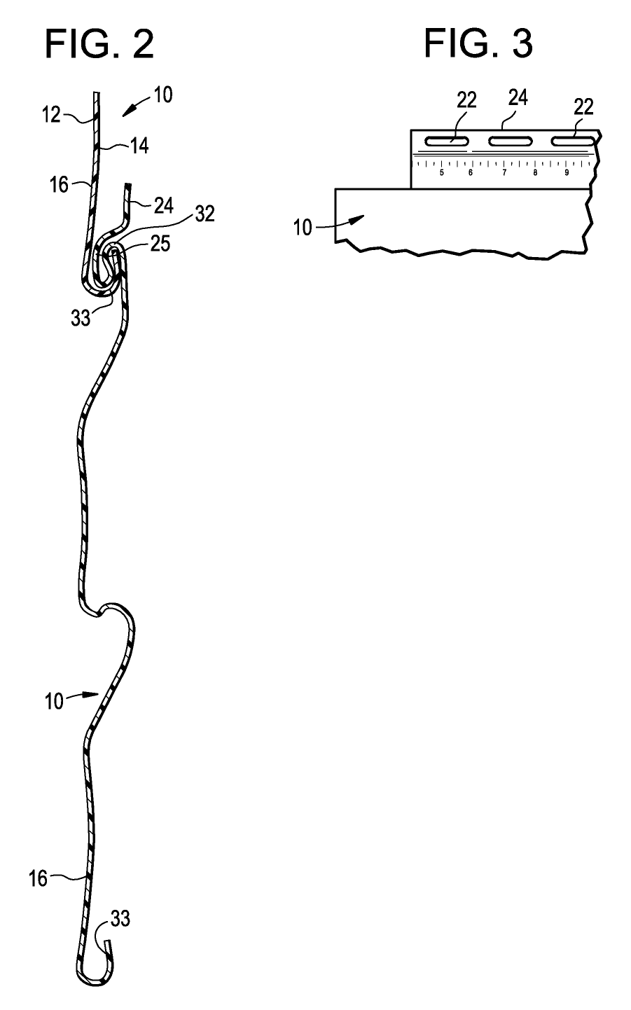

Referring to the drawings and with particular reference to the claims herein, FIG. 1 shows a vinyl siding panel 10 as it comes from the factory having an exemplary cross-section configuration shown enlarged for clarity in FIG. 2, with a front surface 12, an upper portion 14, a lower portion 16, a left end edge portion 18 and right end edge portion 20. A locking lip portion 25 and a nailing flange 24 with nailing apertures 22 are located on the upper portion 14.

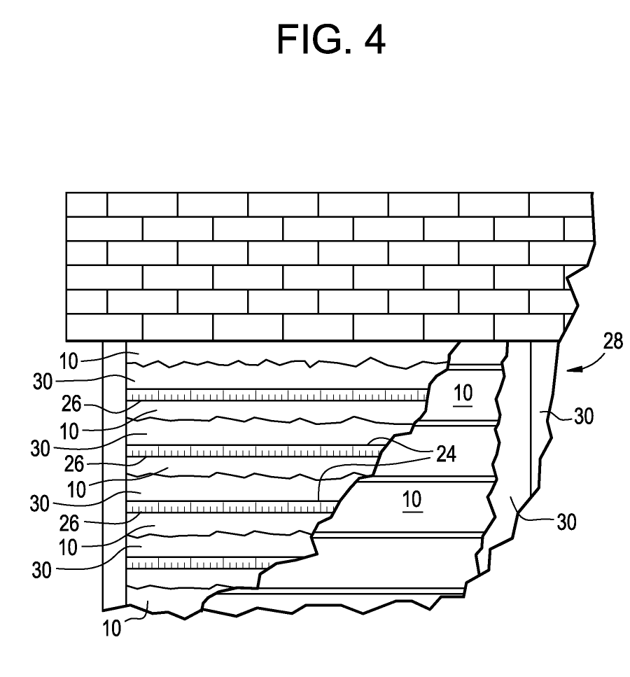

Thus, the upper portion 14 generally includes the locking lip portion 25 and the nailing flange 24 having the nailing apertures 22. The upper portion 14 thereby extends longitudinally along the length of the vinyl siding panel 10, and is typically hidden behind a lower portion 16 of an adjacent vinyl siding panel 10 when the adjacent panels are affixed to a building structure, as illustrated in FIGS. 2 and 4.

Linear measure markings, generally designated 26, are marked on the upper portion 14 by printing or the like, in easily readable form such as on conventional tape measures, and are detailed as desired, e.g., starting with zero at one of the end edge portions 18, 20 and continuing progressively along the entire length of the vinyl siding piece in increments of, but not limited to, ±¼ inch. The linear measure markings are thus placed at fixed intervals, progressively and continuously in a non-repetitive manner, to reflect the actual longitudinal length of the vinyl siding piece. This calibrated marking is an index so that a user need only view the vinyl siding to ascertain which part of the vinyl siding needs to be cut to obtain a pre-determined length without actually measuring the vinyl siding. In other words, the user can easily ascertain the dimensions of the piece of siding merely by viewing the markings on the edge of the piece of siding.

Thus, according to the present invention, an elongated piece of pre-finished vinyl siding 10 adapted to be cut to a measured length at a worksite and to be affixed to a structure, includes an upper portion 14 having a nailing flange 24 and a locking lip portion 25, and linear dimension markings 26 non-repetitively and incrementally provided exclusively on the upper portion 14, wherein the linear dimension markings 26 increase sequentially from a first end edge 18 to a second end edge 20 of the vinyl siding along an entire length of the vinyl siding 10, thereby visually indicating where to cut the vinyl siding to obtain the measured length. Preferably, the linear dimension markings are formed on the upper portion, such as on the locking lip portion 25 or the nailing flange 24, so as to be completely hidden from view when the vinyl siding is affixed adjacently with other vinyl siding pieces to a structure.

Thus, with respect to placement of the markings 26, as shown in FIGS. 1 and 2, for example, it is preferred that the markings be placed on a portion of the siding which will be covered over with portions of an adjacent piece of siding during the siding installation, such as on the locking lip portion 25 of the upper portion 14 which is covered over by the lower portion 16 of an upper adjacent vinyl siding panel. It is noted that for siding panels wherein the nailing flange and/or locking lip portion does not extend all the way to the end edge, e.g. 18, of the panel, such as the case of an inset left edge as shown in FIG. 3, the linear dimension numbering can invisibly start at the edge but the viewable printing on the locking lip portion 25 will pick up inwardly of the edge. Still further, the markings can be placed on a reverse side of the vinyl siding panel, that is, a side opposite to the front surface 12.

As described above, the markings of the present invention are continuous measurement indicia for cutting the vinyl siding without a tape measure. The markings are non-repetitive and continuous from one end to the other end of the siding, allowing a user to determine a total length of the piece to be cut without requiring the use of any measuring steps, calculations, or additional measurement guides, e.g. a ruler, calculator, etc.

With this feature, a user does not expend any effort to measure the piece of vinyl siding itself, thus saving time and labor. In practice, once a desired length of the vinyl siding is determined, such as the desired length of siding required on the wall of a building structure, the user only needs to visualize the linear indicia markings on the piece of siding, locate the desired marking and cut the piece at the indicia which indicates the desired length. No measurements, calculations or additional sizing steps are required to cut the vinyl siding to the appropriate length.

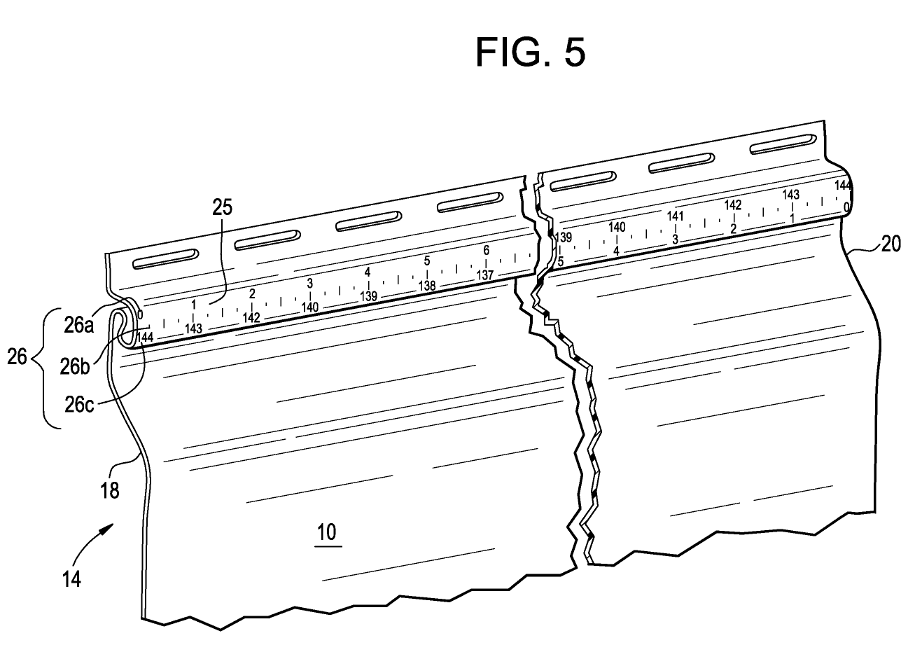

The linear dimension markings may comprise three parallel rows of markings as illustrated in detail in FIG. 5. A first row 26a of numerical characters or measurement indicators sequentially increase at predetermined intervals, starting at zero at the first end edge and ending at n at the second end edge, wherein n equals a total length of the vinyl siding. A second row 26b includes incremental line markings placed at fixed intervals, such as ¼ inch increments. A third row 26c of numerical characters or measurement indicators sequentially increase at the predetermined intervals, starting at zero at the second end edge and ending at n at the first end edge, wherein n equals the total length of the vinyl siding. The second row of incremental markings coincides in linear positions with each of the first and second row of numerical measurements, wherein every fourth line marking coincides with the numerical characters of the first and third row. Thus, the second row allows the first and third rows to be viewed at ¼ inch increments without having to include each ¼ inch numerical character, thus, making the markings easier to read.

When the linear dimension markings are made by an ink jet printer, for example, the compilation of the linear dimension markings comprising the three parallel rows is referred to as a “code”. The code of the present invention has an extended length as compared to conventional code because it should extend along the entire length of the vinyl siding, which is typically 144 inches. In addition, a height of the characters in the code in the present invention is generally ⅜ inch high.

As noted above, the linear dimension markings may be on a back side of the vinyl siding which is not visible after the vinyl siding is affixed to a structure. Moreover, even if the linear dimension markings are on the front surface 12 of the vinyl siding, it does not require additional painting to hide the markings, because the longitudinally extending upper edge portion (upper portion 14) underlies a longitudinally extending lower edge portion (lower portion 16) of an adjacent piece of vinyl siding when the vinyl siding is affixed to a structure.

Further, the present invention comprises the combination of a building structure 28 having an exterior wall 30 of, e.g., plywood sheets, with vinyl siding panels 10 affixed thereto in a generally vertically successive manner, wherein each siding panel has upper portion 14 with a longitudinally extending nailing flange 24 and a locking lip portion 25, wherein linear dimension markings 26 are provided on the nailing flanges 24 or the locking lip portion 25 substantially the full lengths thereof, and wherein the panels are affixed to the wall by nailing the flanges thereto. As shown in FIG. 2, the upper portion 14 of each panel is provided with a longitudinally extending first shoulder 32, wherein a lower portion 16 of each panel is provided with a longitudinal extending second shoulder 33, interlocked with the first shoulder of an adjacent panel and the lower portion 16 of each successive upper panel overlies the nailing flange and markings of the adjacent lower panel.

Consistent with the present invention, a group of elongated pre-finished vinyl siding panels may be provided, each of which has an upper portion extending longitudinally along a length of the vinyl siding panel, a lower portion extending longitudinally along the length of the vinyl siding panel, a first end edge and a second end edge. Each vinyl siding panel is provided with highly visible linear measure markings on the upper portion, whereby the vinyl siding panel can be cut by an installer to a desired length utilizing, for measuring, only the markings and without the need for any other measuring device, wherein the markings are non-repetitively, continuously increasing from zero at the first end edge to n at a second edge end, wherein n equals the total length of the vinyl siding.

The initially viewable surface portion of each siding piece includes the locking lip portion and the nailing flange, wherein the vinyl siding pieces are affixed in typical assembly manner to a building wherein an upper vinyl siding panel is adjacent to a lower vinyl siding panel of the same construction and has its lower longitudinal edge portion overlying the upper longitudinal edge portion of the lower vinyl siding panel and obscuring the markings on the initially viewable surface portion of the lower vinyl siding panel.

The markings may run progressively in opposite directions longitudinally of each piece of vinyl siding on the upper portion. As mentioned above, such linear dimension markings may include three parallel rows as illustrated in FIG. 5.

With this structure for the markings, since they run in opposite directions, each vinyl siding panel can be measured from either side to reduce waste. Thus, if a single 15 foot piece of siding is initially cut to a desired length to obtain a first cut piece, such as 8 ft. 1 in. as measured from the first end edge, the remaining piece of 6 ft. 11 in. piece can then still be used just as conveniently by measuring from the second end edge to obtain a second cut piece without requiring any additional measurement tools.

The markings can, of course, be in any language, of any character style, of any color and placed on any visible, viewable portion of the vinyl siding, but along an edge thereof which will become covered over is the preferred location. As noted above, the markings can be provided on a back side of the vinyl siding so as not to be visible after the siding is affixed to the structure.

A continuous ink jet or laser are preferred ways to apply the markings during manufacture of the vinyl siding, whereby the print could be rapidly and automatically applied to the vinyl siding during the continuous extrusion process. Thus, when the vinyl siding is received by the cutter/installer for cutting and installation, the linear dimension markings are pre-printed thereon.

As noted above, a continuous ink jet printer is one of the preferred methods for applying markings to the vinyl siding. However, the application of a continuous ink jet in a continuous extrusion process, as opposed to conditions in which an extruder are not present, entails complex technical requirements. Namely, the use of the continuous ink jet printing to a product being continuously extruded requires tight and responsive control over the printing process in response to the linear velocity of the extrusion line. In other words, the speed of the printing must be continuously controlled to correspond with the variable speed of the extruder. Moreover, printing linear measurement indicia on an extruded product, such as vinyl siding, requires a high degree of control, since such linear markings must be printed accurately with very little tolerance, i.e., ±¼ inch over the entire length of the vinyl siding panel. Thus, it is important to control the physical location of the product in a three-dimensional x, y and z plane relative to the print head.

Due to the complex nature of continuous ink jet printing of linear measurement indicia on an extruded product, these various control problems have been identified and solved by the inventors using the novel printing method which will now be discussed in detail. The ability to control the extruded product and synchronize a continual printing process over an extended length within ±¼ inch has never before been developed or achieved. Up to now, there have been no conventional methods for printing an extruded product within ±¼ inch increments.

According to the present invention, a print station in a free standing support framework (not shown) is located adjacent to an extruder device (not shown). As the extruded vinyl siding product (otherwise known as a substrate) exits the extruder and prior to being cut, the material enters a series of roller sets that contact the top and bottom of the substrate. A set of lower rollers are coated with a urethane finish. These lower rollers are driven by an electric motor that can be synchronized with the speed of the substrate exiting from the extruder line. The lower rollers that are driven by the electric motor have an over-speed clutch installed to allow the drive rollers to free wheel should the substrate be driven at a faster speed than the drive rollers. A set of upper rollers are made of a metallic non-marring material. The upper rollers are contoured to trap and guide the substrate using a top lock or other stiffening ribs in the substrate.

A contact encoder or a non-contact laser encoder can be used for detecting the leading edge of the substrate as it exits the extruder. With respect to the non-contact laser encoder, inside the framework and just prior to the first set of rollers, a non-contact laser gauge detects the leading edge of the substrate as it enters the print station and also determines the linear velocity of the substrate. This gauge outputs a signal to the ink jet printer to begin the print process. In addition, the gauge outputs a quadrature signal to the printer which the printer will use to determine the print speed. The signal from the gauge is also shared with the motor drive controller in the framework. This signal provides compensation to the drive unit should the extruder line speed change.

Alternatively, with respect to the contact encoder, inside the framework and just prior to the first set of rollers, a thru-beam photocell may be provided that will sense the leading edge of the substrate as it enters the print station. This sensor will send a signal to the ink jet printer to begin the print process. Mounted just past the first set of rollers is a low inertia contact wheel that is attached to an incremental encoder. When the low inertia contact wheel contacts the substrate and begins to rotate, the sensor outputs a quadrature signal to the printer to set up the print speed. The encoder signal is also shared with the motor drive controller in the framework. This signal provides compensation to the drive unit should the extruder line speed change.

With both the contact encoder and the non-contact laser encoder, the print process is managed until the end of the substrate is reached. As the substrate exits the framework, the material falls into a stack awaiting an operator's action, such as for packaging the material into containers for storage and transport.

To date, continuous ink jet printers have the limitation of only being able to effectively print up to ¾ inch of code height at the same time. This is a limitation due to the “throw distance”, which is the distance between the print head and the surface of the product to be printed. Conventionally, the throw distance is ¾ inch. With continuous ink jet technology, this limitation in throw distance, along with the speed at which the product is traveling, will determine the quality of the actual code. The quality of the code at excessive printing speeds, or at an excess of this maximum throw distance can result in poor legibility and therefore defeats the very purpose of applying a code. The majority of single head continuous ink jet codes are actually less than ¾ inch in height, including up to four lines of code.

In order for the present invention to be useful for an installer of a self-measuring vinyl siding piece, the code must extend along the entire length of the vinyl siding piece, be accurate within the ±¼ inch tolerance, and be easily legible in the installing environment. To achieve this, the code must meet, among other specifications, a desired character height of ⅜ inch. The majority of extruders run in excess of 100 FPM and up to 250 FPM. The ability to accurately and legibly print extended length code at these speeds is not possible with conventional technology. While the technology for synchronizing two printers is generally known in the art for printing conventionally sized code, in order to manufacture the extended length code that is used in the present invention, e.g., about 144 inches, software has been developed which synchronizes one or more continuous ink yet printers to be able to print, as essentially one printer, the extended length code. Two or more printers are required because of the amount of information (code) being processed, and the speed at which this is done. Since an extruder by design cannot be stopped mid-process it may also be necessary to be able to hot swap a printer and resynchronize with the second printer to continue the application of the measurement indicia, i.e., code.

Verification of the markings being applied includes an option for a vision verification system that confirms that printing is being done within the accepted tolerances at all times. If for some reason the extruder speed changes outside of the normal specifications or a fault is experienced with the printing process, an alert is activated to notify the operator.

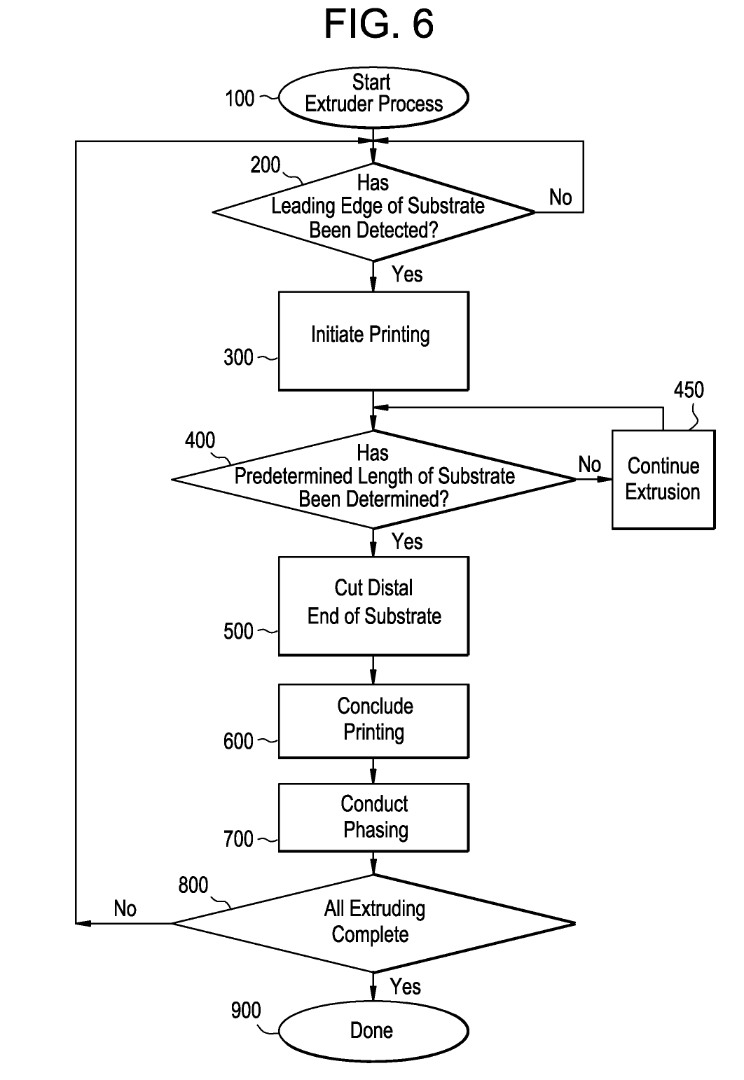

FIG. 6 illustrates a flow chart outlining the steps for printing at the extruder machine. As in conventional printing methods, the printing may be automatically controlled with software. First, initiation of a conventional extruder device operation to extrude a piece of vinyl siding (substrate) is performed (step 100). Next, if the leading end of the substrate is detected by the encoder, i.e., the leading edge exits the extruder (step 200), printing is initiated (step 300) as the leading edge enters the printing device, and the markings are printed on the vinyl siding in a continuous manner starting with the leading edge of the substrate. Thus, the printing process is conducted simultaneously with the extruding process as the substrate exits the extruder. An external sensor may be used to integrate the operation of ink jet printer with the automatic extruder production line. The sensor generates a “print-go” signal when the leading edge of the substrate approaches the print head and printing is to be started. Another sensor is required if the printing speed is to be adapted automatically to fluctuating product speeds in order to produce a print of constant length.

During the printing process, a controller determines when the piece of extruded siding has reached a predetermined length (step 400), such as 144 inches. If the predetermined length of extruded product has not been reached, the extrusion process is continued (step 450) while the printing process continues. If the predetermined length of extruded product has been reached, simultaneously while the printing process continues, the piece of vinyl siding is cut by a chopper/cutter device (step 500). After the siding is cut by the chopper/cutter device, the printing process continues until the distal end (cut end) of the substrate is printed by the printer, at which time printing of the subject substrate is concluded (step 600).

Upon completion of the printing, a phasing process (step 700) is conducted. Phasing involves the analysis and adjustment of the static charge being placed on the ink drops. While conventional printing methods perform the phasing process, which delays printing, continuously in between the application of each code, in the present invention the phasing step can only be conducted after each printing step (i.e., printing of one extended length code which is applied to the entire length of the panel) due to the length of the code, the immense printing speeds and the accuracy required.

More specifically, due to the unique requirement of having to print in excess of 415 characters per second or approximately 25,000 characters per minute, all within a tolerance of ±¼ inch over an extended length of extruded product, standard printing methods are not effective for printing the linear measurement indicia of the present invention on an extruded product. The novel concept of being able to print a visual measurement guide at these speeds has been made possible due to the inventive modifications in technology and programming. That is, the phasing is delayed if the code is being applied in order to maintain an accurate printing process within specifications. Typically in conventional printing scenarios, software automates the printer device so that the phasing signal is not to be interrupted; however, due to the speeds and accuracy requirements for the present invention, this modification to traditional methods is necessary.

Thus, is in the present invention, the printing of each piece of vinyl siding is completed before each phasing step is conducted. Thus, the extrusion of the next substrate is performed (if necessary) after the phasing step 700 is concluded, and a technician or controller determines whether all extruding is finally complete (step 800). In general, the panels are printed every 3-4 seconds during which 1200-1500 characters must be printed. The phasing step requires about 5-7 milliseconds between each panel printing, therefore conducting the phasing step only between printing of the extended length codes should not pose a significant delay. Once a desired number of substrates have been extruded, the process is completed (step 900).

With respect to the timing arrangement of the phasing step, in conventional methods codes are generally 6-20 characters and two inches in length. After such a conventional code is applied, it is either repeated (referred to as a repeat print) or serialized (which means it incrementally increases with each print), and the phasing may be conducted between each code application. Thus, in conventional methods, a printer normally conducts phasing intermittently without any concern about impacting the location of the print. However, this conventional manner of phasing intermittently would be detrimental in the present invention. The extended length code of the present invention is 144 inches long, comprises 960 codes based on an average of 80 codes per foot of panel, and must have a tolerance of ±¼ inch. Conducting phasing during the printing of the extended length code would impact the acceptable tolerance, causing inaccuracies in the linear measurement indicia and ultimate cut product. Thus, the phasing step cannot be conducted until after the entire panel has been printed with the extended length code.

The actual phasing may be performed in a conventional manner. For example, ink drops cross an area of a phase electrode where the charge of the drops is checked by a phasing module.

Although the preferred method for applying the markings (code) is performed simultaneously with the extrusion and cutting steps as described above, the present invention is not limited to this timing of application and thus the marking process could be conducted after the extrusion and cutting steps as well.

One embodiment of the invention resides in a computer system. Here, the term “computer system” is to be understood to include at least a memory and a processor. In general, the memory will store, at one time or another, at least portions of an executable program code, and the processor will execute one or more of the instructions included in that executable program code. It will be appreciated that the term “executable program code” and the term “software” mean substantially the same thing for the purposes of this description. It is not necessary to the practice of this invention that the memory and the processor be physically located in the same place. That is to say, it is foreseen that the processor and the memory might be in different physical pieces of equipment or even in geographically distinct locations.

The invention may be embodied in a computer program product, as will now be explained.

On a practical level, the software that enables the computer system to perform the operations described above in detail may be supplied on any one of a variety of media. Furthermore, the actual implementation of the approach and operations of the invention are actually statements written in a programming language. Such programming language statements, when executed by a computer, cause the computer to act in accordance with the particular content of the statements. Furthermore, the software that enables a computer system to act in accordance with the invention may be provided in any number of forms including, but not limited to, original source code, assembly code, object code, machine language, compressed or encrypted versions of the foregoing, and any and all equivalents.

One of skill in the art will appreciate that “media”, or “computer-readable media”, as used here, may include a diskette, a tape, a compact disc, an integrated circuit, a ROM, a CD, a cartridge, a remote transmission via a communications circuit, or any other similar medium usable by computers. For example, to supply software for enabling a computer system to operate in accordance with the invention, the supplier might provide a diskette or might transmit the software in some form via satellite transmission, via a direct telephone link, or via the Internet. Thus, the term, “computer readable medium” is intended to include all of the foregoing and any other medium by which software may be provided to a computer.

Although the enabling software might be “written on” a diskette, “stored in” an integrated circuit, or “carried over” a communications circuit, it will be appreciated that, for the purposes of this application, the computer usable medium will be referred to as “bearing” the software. Thus, the term “bearing” is intended to encompass the above and all equivalent ways in which software is associated with a computer usable medium.

For the sake of simplicity, therefore, the term “program product” is thus used to refer to a computer usable medium, as defined above, which bears in any form of software to enable a computer system to operate according to the above-described method of the present invention. Thus, the invention is also embodied in a program product bearing software which enables a computer to perform management of information according to the invention. The computer readable medium could be read by a CPU through a medium reader, for example.

A method of cutting a piece of vinyl siding, at a worksite, having pre-printed linear dimension markings thereon as described above, includes determining a desired length for the vinyl siding with reference to a structure to which the vinyl siding is to be affixed, viewing the pre-printed linear dimension markings on the vinyl siding to locate a corresponding one of the pre-printed linear dimension markings that equals the desired length, thereby determining a position on the vinyl siding to be cut without using an additional measurement tool, and cutting the vinyl siding at the corresponding linear dimension marking that equals the desired length.

A piece of vinyl siding according to the present invention is manufactured with the linear measurement markings provided thereon by printing. In particular, the method includes extruding a vinyl siding panel from an extruder, and printing linear dimension markings along a longitudinal upper edge portion of the vinyl siding panel as it exits from the extruder. Since the linear measurement markings begin (either visibly or invisibly) at zero at one end edge of the vinyl siding panel (e.g., a leading edge of the extruded substrate), and continue progressively in increments, such as ¼ inch, until reaching a second end edge (e.g., a distal end of the extruded substrate), a user does not require any additional measurement devices or calculating steps to measure a length of the siding panel to be cut.

The present invention has heretofore been described with respect to vinyl siding. A piece of vinyl siding as understood for purposes of the foregoing description, is directed to a pre-finished piece of vinyl siding which is in its final form and only requires cutting to a specific measured size before being affixed to a desired location such as a building structure but does not require any further finishing such as painting or staining.

In a further aspect of the invention, a piece of PVC tubing, adapted to be cut a measured dimension at a worksite, may be used. The PVC tubing may include a viewable surface extending longitudinally on the PVC tubing and linear dimension markings non-repetitively and incrementally provided on the viewable surface, wherein the linear dimension markings increase sequentially from a first end edge to a second end edge of the PVC tubing along an entire length of the PVC tubing, thereby visually indicating where to cut the PVC tubing to obtain the measured dimension. The linear dimension markings may include the three parallel rows of markings discussed in detail above. Moreover, the PVC tubing is printed using the same steps discussed above for vinyl siding.

This invention has been described in detail with particular reference to preferred embodiments thereof, but it will be understood that variations and modifications will be effected within the spirit and scope of the invention.

What is claimed is:

1. An elongated piece of pre-finished vinyl siding adapted to be cut to a measured length at a worksite and to be affixed to a structure, said vinyl siding comprising:
an upper portion that includes a nailing flange and a locking lip portion; and
linear dimension markings non-repetitively and incrementally provided exclusively on said upper portion, wherein said linear dimension markings increase sequentially from a first end edge to a second end edge of said vinyl siding along an entire length of said vinyl siding, thereby visually indicating where to cut the vinyl siding to obtain the measured length, and
wherein said linear dimension markings are completely hidden from view when said vinyl siding is affixed adjacently with other vinyl siding pieces to the structure.

2. The vinyl siding according to claim 1, wherein the linear dimension markings comprise three parallel rows of markings, said three rows including:
a first row of numerical characters which sequentially increase at predetermined intervals, starting at zero at the first end edge and ending at n at the second end edge, wherein n equals a total length of the vinyl siding;
a second row of incremental line markings placed at ¼ inch increments; and
a third row of numerical characters which sequentially increase at the predetermined intervals, starting at zero at the second end edge and ending at n at the first end edge, wherein n equals the total length of the vinyl siding, and
wherein every fourth line marking of the second row of incremental line markings coincides in linear position with each of the first and third row of numerical characters.

3. The vinyl siding according to claim 2, wherein said linear dimension markings are exclusively provided on the locking lip portion of the upper portion.

4. The vinyl siding according to claim 2, wherein said linear dimension markings are exclusively provided on a back side of the upper portion of the vinyl siding which is not visible after the vinyl siding is affixed to a structure.

5. The vinyl siding according to claim 3, wherein, when the vinyl siding is affixed to the structure, the raised locking lip underlies and engages with a longitudinally extending lower portion of an adjacent piece of vinyl siding, so that no portion of the linear measurement markings are visible.

6. A group of elongated pre-finished vinyl siding panels, each of which has an upper portion extending longitudinally along a length of the vinyl siding panel, a lower portion extending longitudinally along a length of the vinyl siding panel, a first end edge and a second end edge, wherein each said vinyl siding panel is provided with highly visible linear measure markings on the upper portion, whereby the vinyl siding panel can be cut by an installer to a desired length utilizing, for measuring, only said markings and without the need for any other measuring device, wherein said markings are non-repetitively, continuously increasing sequentially from zero at the first end edge to n at the second end edge, wherein n equals a total length of the vinyl siding panel, and wherein said upper portion includes a nailing flange and locking lip portion of said vinyl siding panel, and wherein the vinyl siding panels are affixed in typical assembly manner to a building wherein an upper vinyl siding panel is adjacent to a lower vinyl siding panel of the same construction and the lower portion of the upper vinyl siding panel overlies the upper portion of the lower vinyl siding panel and obscures the markings on the upper portion of said lower vinyl siding panel.

7. The vinyl siding panels of claim 6, wherein the linear dimension markings comprise three parallel rows of markings, said three rows including:
a first row of numerical characters which sequentially increase at predetermined intervals, starting at zero at the first end edge and ending at n at the second end edge, wherein n equals a total length of the vinyl siding panel;
a second row of incremental line markings placed at ¼ inch increments; and
a third row of numerical characters which sequentially increase at the predetermined intervals, starting at zero at the second end edge and ending at n at the first end edge, wherein n equals the total length of the vinyl siding panel, and
wherein every fourth line marking of the second row of incremental line markings coincide in linear position with each of the first and third row of numerical characters.

8. The vinyl siding panels of claim 7, wherein said linear dimension markings are exclusively provided on the locking lip portion of the upper portion of each of the siding panels.

9. The vinyl siding panels of claim 7, wherein said linear dimension markings are exclusively provided on a back side of the upper portion of the vinyl siding which is not visible after the vinyl siding is affixed to a structure.

10. A method of cutting a piece of vinyl siding having pre-printed linear dimension markings thereon, wherein the markings are continuously and non-repetitively provided on a surface of the vinyl siding, increasing sequentially from a first end edge to a second end edge of said vinyl siding along an entire length of said vinyl siding, thereby visually indicating where to cut the vinyl siding, comprising:
determining a desired length for the vinyl siding with reference to a structure to which the vinyl siding is to be affixed;
viewing the pre-printed linear dimension markings on the vinyl siding to locate a corresponding one of the pre-printed linear dimension markings that equals the desired length, thereby determining a position on the vinyl siding to be cut without using an additional measurement tool; and
cutting the vinyl siding at the corresponding linear dimension marking that equals the desired length.

11. The method of cutting according to claim 10, wherein said linear dimension markings are exclusively provided on a locking lip portion that extends longitudinally along the length of an upper portion of the vinyl siding.

12. A piece of PVC tubing, adapted to be cut to a measured length at a worksite, said PVC tubing comprising:
a viewable surface extending longitudinally on the PVC tubing; and
linear dimension markings non-repetitively and incrementally provided on said viewable surface, wherein said linear dimension markings increase sequentially from a first end edge to a second end edge of said PVC tubing along an entire length of said PVC tubing, thereby visually indicating where to cut the PVC tubing to obtain the measured length.

13. The PVC tubing according to claim 12, wherein the linear dimension markings comprise three parallel rows of markings, said three rows including:
a first row of numerical characters which sequentially increase at predetermined intervals, starting at zero at the first end edge and ending at n at the second end edge, wherein n equals a total length of the PVC tubing;
a second row of incremental line markings placed at ¼ inch increments; and
a third row of numerical characters which sequentially increase at the predetermined intervals, starting at zero at the second end edge and ending at n at the first end edge, wherein n equals the total length of the PVC tubing, and
wherein every fourth line marking of the second row of incremental line markings coincides in linear position with each of the first and third row of numerical characters.

14. A method of manufacturing a pre-finished vinyl siding panel with linear dimension markings, comprising:
extruding a vinyl siding panel from an extruder;
printing linear dimension markings, with a printer, along a longitudinal upper portion of the vinyl siding panel simultaneously with the extruding step, upon detection of a leading edge of the vinyl siding panel reaching the printer;
simultaneously with a continued process of the printing step, cutting a distal end of the vinyl siding panel upon detection that a predetermined length of the vinyl siding panel has been extruded from the extruder;
after the cutting step, continuing the printing step without interruption until a distal end portion of vinyl siding has been printed and stopping the printing step; and
after the printing step has stopped, conduct a phasing process for analyzing and adjusting a static charge placed on ink drops of the printer.

15. The method according to claim 14, further comprising: repeating the extruding, printing, cutting and phasing steps until a predetermined number of vinyl siding panels has been extruded.

16. The method according to claim 14, wherein said linear dimension markings comprise three parallel rows of markings, said three rows including:
a first row of numerical characters which sequentially increase at predetermined intervals, starting at zero at the first end edge and ending at n at the second end edge, wherein n equals a total length of the vinyl siding panel;
a second row of incremental line markings placed at ¼ inch increments; and
a third row of numerical characters which sequentially increase at the predetermined intervals, starting at zero at the second end edge and ending at n at the first end edge, wherein n equals the total length of the vinyl siding panel, and
wherein every fourth line marking of the second row of incremental line markings coincides in linear position with each of the first and third row of numerical characters.

17. A combination of a building structure having an exterior wall with vinyl siding panels affixed thereto in a generally horizontal assembly and vertically successive manner to provide upper and lower adjacent panels, wherein each said panel has a longitudinally extending upper portion including a nailing flange and locking lip portion, wherein linear dimension markings are provided non-repetitively, sequentially increasing incrementally on said upper portion substantially the full length thereof, wherein said panels are affixed to said wall by nailing said flanges thereto, wherein the upper portion of each said panel is provided with a longitudinally extending first shoulder means, wherein a lower portion of each said panel is provided with a longitudinally extending second shoulder means, wherein said first and second shoulder means of adjacent panels are interlocked to prevent movement of the lower portion of each panel away from said wall, and wherein the lower portion of each successive upper panel overlies the upper portion and markings of the adjacent lower panel.

18. A computer program product for enabling a computer to manage manufacturing of a pre-finished vinyl siding panel with linear dimension markings, comprising:
software instructions for enabling the computer to perform predetermined operations, and
a computer readable medium bearing the software instructions;
the predetermined operations including the steps of:
extruding a vinyl siding panel from an extruder;
printing linear dimension markings, with a printer, along a longitudinal upper portion of the vinyl siding panel simultaneously with the extruding step, upon detection of a leading edge of the vinyl siding panel reaching the printer;
simultaneously with a continued process of the printing step, cutting a distal end of the vinyl siding panel upon detection that a predetermined length of the vinyl siding panel has been extruded from the extruder;
after the cutting step, continuing the printing step without interruption until a distal end portion of vinyl siding has been printed and stopping the printing step; and
after the printing step has stopped, conduct a phasing process for analyzing and adjusting a static charge placed on ink drops of a printer fluid of the printer.
